(19) United States
(12) Patent Application Publication
(10) Pub. No.: US 2007/0115998 A1
(43) Pub. Date: May 24, 2007

(54) Method and software product for identifying network devices having a common geographical locale

(76) Inventor: Adrian Edwin McElligott, Griffin, Queensland (AU)

Correspondence Address: CONLEY ROSE, P.C., P. O. BOX 3267, HOUSTON, TX, 77253-3267, US

(21) Appl. No.: 11/548,822

(22) Filed: Oct. 12, 2006

Related U.S. Application Data
(60) Provisional application No. 60/732,782, filed on Nov. 2, 2005.

(51) Int. Cl. H04L 12/56

(52) U.S. Cl. 370/392; 370/401

(57) ABSTRACT

A method and software product for identifying network devices having a common geographical locale. At least some of the illustrative embodiments are methods to associate a geographical location with network data including network edge address data and corresponding pivot data comprising storing network data with corresponding known geographical locations, subsequent to ascertaining new network data checking if pivot data contained therein matches pivot data of said stored network data, and if so associating the new network data with a geographical location previously associated with said matched pivot data.

### CROSS REFERENCE TO RELATED APPLICATIONS

This application claims the benefit of provisional patent application Ser. No. 60/732,782 filed Nov. 2, 2005 titled, “Method and software product for identifying network devices having common geographical locale,” and which provisional application is incorporated by reference herein as if reproduced in full below.

### BACKGROUND

1. Field of the Invention

The present invention relates to a method and software product for determining the geographical locale of Internet-connected computational devices.

2. Background to the Invention

In U.S. patent application publication number 20030009594 to the present inventor, which is hereby incorporated in its entirety by reference, there is described a method for determining the geographical locale of an Internet-connected computer. As explained in the above-referenced patent application, if the geographical locale of a remote computer is known then the content of a website being browsed by the remote computer can be dynamically customised. Such customisation is particularly desirable in the context of presenting web-pages containing locale-relevant advertising, for example.

One embodiment of the method that is described in the above-referenced U.S. patent application involves transmitting a burst of specially tailored ICMP packets to remote Internet routers and monitoring response packets from the routers. A problem that has gradually arisen over the last few years is that, due to security concerns, many Internet routers, commonly called stateful packet inspection (SPI) routers are now programmed to ignore unsolicited ICMP packets. For example, some SPI routers may simply record the destination IP Addresses of the external host, from outbound packets and then accept only data packets identified as coming from these hosts.

Accordingly, a problem has arisen in that it has become increasingly difficult to maintain accurate data tables relating IP Addresses to geographical location using methods that rely upon remote routers responding to unsolicited ICMP packets.

It is an object of the present invention to provide a method that addresses the above-described problem, or which is at least a useful alternative to hitherto known methods for deriving information about a remote network connection across a computer network.

### SUMMARY

According to a first aspect of the present invention there is provided a method to associate a geographical location with network data including network edge address data and corresponding pivot data, the method including the steps of:

storing network data with corresponding known geographical locations;

subsequent to ascertaining new network data checking if pivot data contained therein matches pivot data of said stored network data; and if so

associating the new network data with a geographical location previously associated with said matched pivot data.

The network data will preferably include any one of the following:

network edge address data associated with a remote user identifier; or

network edge address data associated with a network support device address.

In one embodiment the network data includes network edge address data associated with a remote user identifier wherein the network edge address data comprises the pivot data.

In an alternative embodiment the network data comprises network edge address data associated with a remote user identifier wherein the remote user identifier comprises the pivot data.

The network data may include network edge address data associated with a network support device address wherein the network support device address data comprises the pivot data

Preferably the method further includes ascertaining the network support device address across a computer network by:

obtaining stateful packet inspection (SPI) data from a reply packet from a remote computer connected to the network support device;

transmitting a number of probe packets addressed to the remote computer, said packets incorporating sufficient of said SPI data for the probe packets to be passed by SPI security devices of the computer network; and

deriving the network support device address on the basis of reply packets generated in response to at least some of the number of probe packets.

The method may include adjusting time-to-live (TTL) values of the probe packets so that they take a range of TTL values wherein the TTL to the remote computer falls within said range whereby at least some of the probe packets fall short of the remote computer thereby eliciting said reply packets.

Preferably the method includes:

determining probe packets having the greatest TTL of said range to elicit a reply packet;

obtaining the IP Address of a device of origin of the reply packet; and

deducing the network support device address on the basis of said IP Address.

The method may include:

sending the probe packets with consecutively increasing TTL values until an ICMP reply packet is not received, whereby the last received reply packet is sent from the network support device.

Alternatively, the method may include: sending the probe packets with consecutively decreasing TTL values until an ICMP reply packet is received, whereby the received reply packet is sent from the network support device.

According to a further aspect of the present invention there is provided a method for deriving information about a remote network connection across a computer network, the method including the steps of:

obtaining stateful packet inspection (SPI) data from a reply packet solicited from a remote computer party to the remote network connection;

transmitting a number of probe packets addressed to the remote computer, said packets incorporating sufficient SPI data for the probe packets to be passed by SPI security devices of the computer network; and

deriving the information on the basis of reply packets generated in response to at least some of the number of probe packets

Preferably the method involves adjusting the time-to-live (TTL) values of the probe packets so that they take a range of TTL values wherein the TTL to the remote computer falls within said range whereby at least some of the probe packets fall short of the remote computer thereby eliciting said reply packets.

The information about the remote network connection may comprise the address of the router to which the remote computer is attached.

In one embodiment the method includes:

determining probe packets having the greatest TTL of said range to elicit a reply packet;

obtaining the IP Address of a device of origin of the reply packet; and

deducing the address of the router to which the remote computer is attached on the basis of said IP Address.

Preferably the method includes: sending the probe packets with consecutively increasing TTL values until a reply packet is not received from a router, whereby the last received reply packet is sent from the closest router to the remote computer.

Alternatively, the method may include: sending the probe packets with consecutively decreasing TTL values until a reply packet is received from a router, whereby the received reply packet is sent from the closest router to the remote computer.

In one embodiment the method includes:

maintaining a record of subnet addresses; and

determining whether or not the reply packet has been solicited from a remote computer whose subnet address is already recorded in said record.

The method may include adding the subnet address to said record if the subnet address is not already recorded in said record.

Each address indicator in said record may have an associated username.

Preferably each address indicator in said record will have an associated geographical location.

The method may include:

establishing a connection with a remote computer;

obtaining a user identifier provided by an operator of the remote computer;

determining a geographical location corresponding to the username from the record; and

associating the geographical location with a subnet address derived from the connection.

In one embodiment the method includes:

corresponding the determined geographic location with one of a plurality of stored advertisements each having an associated geographic location; and

displaying the corresponding advertisement on a website to which the remote computer is connected.

The method may include:

establishing a connection with a remote computer;

determining a subnet address for the remote computer;

determine the identity of a router that services the subnet address;

retrieving a geographical location corresponding to the router identity; and

associating the geographical location with the subnet address.

According to a further aspect of the present invention there is provided a computer software product containing instructions for execution by one or more processors in order to implement a method as previously described.

Further preferred features of the present invention will be described in the following detailed description which will refer to a number of figures as follows.

### BRIEF DESCRIPTION OF THE DRAWINGS

For a detailed description of exemplary embodiments, reference will now be made to the accompanying drawings in which:

FIG. 1 is a schematic diagram showing a remote computer network which includes the Internet.

FIG. 2 is a flowchart showing a method for updating a recorded subnet in accordance with an embodiment of the present invention.

FIG. 3 is a schematic diagram showing a remote computer network which includes a number of clusters of subnets interfaced together via the Internet.

FIG. 4 is a flowchart showing a method for updating the recorded geographic location of a remote user in accordance with an embodiment of the present invention.

FIG. 5 is a timing diagram which shows a method for determining the closest router to a user in a computer network in accordance with an embodiment of the present invention.

FIG. 6 is a flowchart showing the steps involved in performing the method shown in FIG. 5.

FIGS. 7 schematically illustrates a first approach to associating a geographical location with network data including a network edge (e.g. “subnet”) address.

FIGS. 8 schematically illustrates a second approach to associating a geographical location with network data including a network edge (e.g. “subnet”) address.

FIGS. 9 schematically illustrates a third approach to associating a geographical location with network data including a network edge (e.g. “subnet”) address.

### DETAILED DESCRIPTION

Throughout this description, and in the appended claims, the term “subnet” is intended to encompass sub-networks as defined by classless addressing. In particular, the term “subnets” refers to the edge of the network, i.e. “network edge”, that services the end user. While classless addressing allows subnets to be broken up in smaller pieces, these pieces generally service the same geographic area.

It is well known that Internet-connected machines which share a common subnet are typically geographically close. For example two machines with IP Addresses 203.30.195.10 and 203.30.195.11 respectively, i.e. having common subnet address portions, can be reasonably expected to be geographically close or at least to service users in close geographical areas. From an implementation perspective, it is also well known that a large percentage of Internet browsers use dynamic IP Addresses, i.e. a personal computer will be allocated a different IP Address, taken from a pool of possible addresses, each time that it connects to the Internet. Further, an operator of the personal computer may use different Internet Service Providers (ISPs) to access the Internet, and so be allocated a dynamic IP Address from a different pool of IP Addresses, at different times.

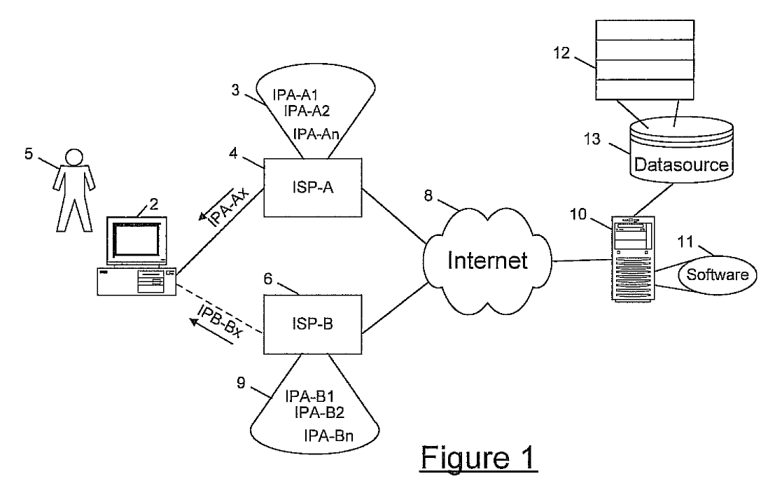

FIG. 1, depicts the above-described scenario. With reference to FIG. 1, an Internet user 5 makes use of personal computer 2, to establish communication with either ISP-A 4 or ISP-B 6. Upon establishing communication, for example with ISP-A 4, the ISP allocates an IP Address IPA-Ax to PC 2. ISP-A 4 then establishes communication between PC 2 and the Internet 8.

According to a preferred embodiment of the present invention, a web-server 10 is provided that includes one or more processors that operate according to instructions coded in software product 11 to implement a method according to the present invention that will be described shortly. Under control of software product 11 the web-server maintains a database 13 relating the identity of an operator 5 of PC 2 to its geographical location. For example, user 5 may have browsed to a webpage generated by server 10. Upon doing so webserver 10 determines PC 2's IP address from its connection with the PC and hence the subnet to which PC 2 is connected. Once at the webpage user 5 may have filled in an online data-capture form presented on a web-page generated by web-server 10 that required the user to enter its location. Upon doing so web-server 10 stores the user's identity, e.g. username and password along with their current [P Address and geographical data in database table 12. Data such as this, which a user provides and which directly relates a subnet to a geographical location will be referred to as “seed data” in the present specification.

Suppose that some time later user 5 operates PC 2 to establish a connection to ISP-B 6 so that PC 2 is allocated an IP Address (IPA) being IPA-Bx from IP Address pool 9. As before, PC 2 then browses the Internet and revisits web-server 10. Upon user 5 of PC 2 logging in to the web-page presented by web-server 10, the web-server checks to determine if IPA-Bx is entered in database table 12 and, in particular, if it is already associated with the geographical location that user 5 had previously entered into the data capture form and which is also associated with IPA-Bx. If IPA-Ax is not already associated with the user's geographical location then the subnet identifier portion of it is stored in table 12 against the geographical locale.

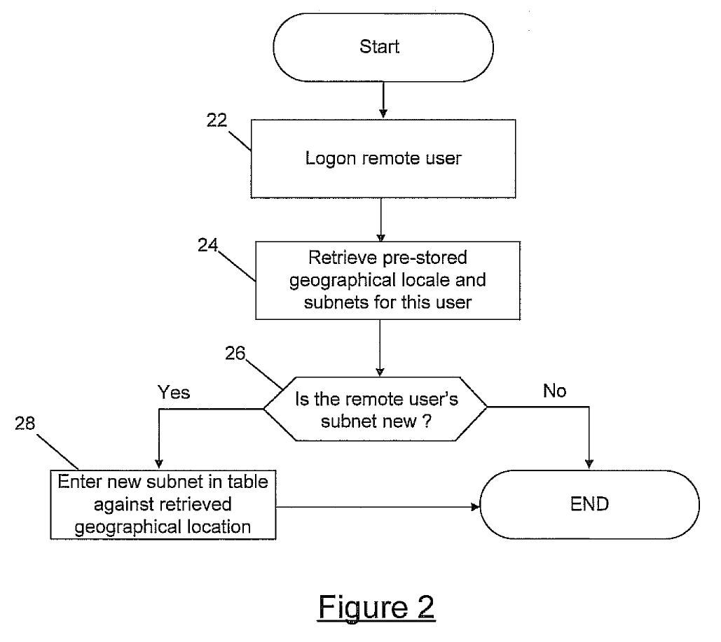

FIG. 2 is a flowchart of a method of operating web-server 10 according to an embodiment of the present invention. Software application 11 contains instructions for one or more processors of web-server 10 to implement the method. At box 22 the web-server presents a logon web-page to user 5 of PC 2. User 5 logs on, for example by entering a username and password. At box 24 the username is used to look up the user's previously submitted geographical location from database table 12. At box 26 a check is performed to determine if the remote user's current subnet, as determined from the IP Address provided by their connection to web-server 10, is the same as previously employed by the user. If it is a different subnet address then it is recorded in table 12 against the retrieved geographical location. Accordingly, table 12 has grown insofar as the approximate geographical location of another subnet has been added.

It will be realised that the above method is based upon a number of assumptions. For example, the user of PC 2 is presumed to always log in with PCs that are in the same geographical locale. It is also assumed that the user submitted their correct geographical location into the data-capture form initially presented by web-server 10 so that the seed data is correct. The inventor has found that in practice these assumptions turn out to be correct in the majority of cases. Furthermore, the more seed data that is collected the more readily apparent it becomes that a particular seed data entry is likely to be erroneous and so should be discarded. For example, the authenticity of a seed point of the seed data may be checked by collaboration within the seed points to determine which ones are correct. A lack of collaboration can then be taken to indicate incorrect entries.

An alternative to the user supplying their location on a web form, as described above, is to deduce the user's location upon them accessing web server 10 from a subnet whose location is already known. This location is then associated with the user and is referred to on further visits when the user's subnet's location is not known. This process may be carried out by analysing server log files; such as, for example, those kept by an advertising server which uses cookies to identify visits from the same user. Even without knowing any of the user's locations the log file information can be used to group subnets that are used by the same user and hence likely to be geographically close to each other. Once the subnets have been grouped it only remains to determine the geographical location of one subnet of each of these groups of subnets in order to determine the location of all of the others.

Those skilled in the art will understand that it is more straightforward to obtain the geographical location of some subnets than others within the same group. Consequently, being able to associate a subnet whose location is known with one whose location is difficult to determine, by means of the methods described above, is highly advantageous.

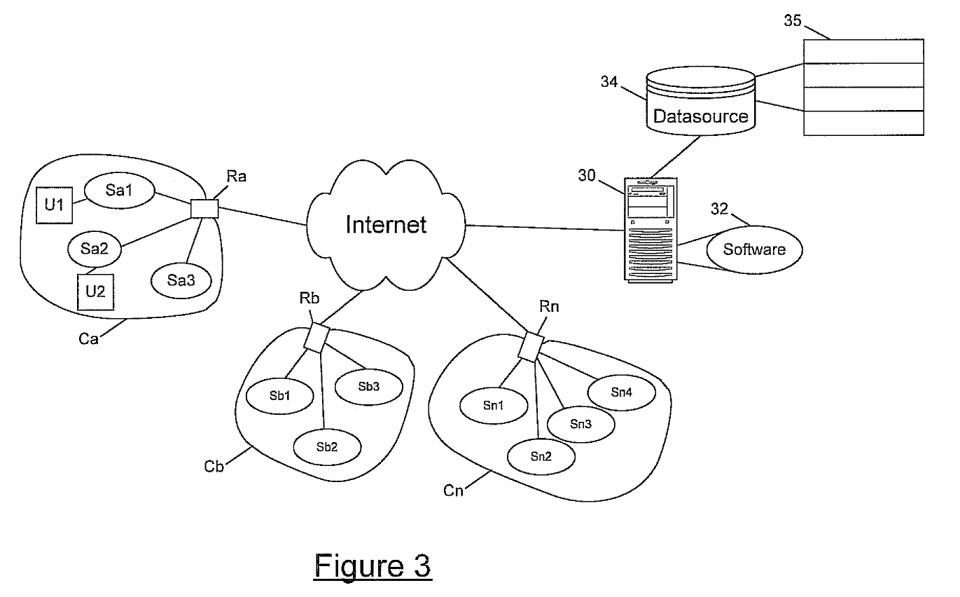

A further embodiment of the present invention will now be described initially with reference to FIG. 3.

FIG. 3 depicts a number of typical routers Ra, Rb, . . . , Rn which each connect a cluster of subnets Ca, Cb, . . . , Cn respectively to the Internet in the usual fashion. Each cluster is made up of a number of subnets. For example, cluster Ca includes subnets Sa1, Sa2, Sa3. The subnets of a particular cluster will tend to service a common geographical area. For example, cluster Ca may service users located in Houston Texas whereas cluster Cb may service users located in Munich Germany. According to an embodiment of the present invention there is also provided a web-server 30 that runs a router-to-subnet association software application 32 and maintains a database 34 having a table 35 that relates subnets to their associated router and in turn to an associated geographical location (serviced by the router).

Suppose that web-server 30 has access to seed data which identifies a user computer U1 as being connected to subnet Sa1, also indicates that Sa1 is located in Houston and further identifies router Ra as being the router that services subnet Sa1. The identity of the subnet will be known from the connection data with web-server 30, the geographical location of Houston will have been captured when user U1 originally filled out a data capture form presented by the web-server. The identity of router Ra can be determined by a router identification method that will be explained later in the present description.

Subsequently another user U2, who is connected to subnet Sa2 and who has not hitherto been known to web-server 30 connects to the web-server. Web-server 30 determines the identity of subnet Sa2 from U2's IP Address and also determines the identity of router Ra. The web-server checks to see if it has an entry for Ra in database table 35. If it does then it looks up the corresponding geographical location. That geographical location is then associated with subnet Sa2. Consequently, it will be realised that if the web-server has access to seed data for a user connected to a subnet in any one of the clusters Ca, Cb, . . . , Cn then upon another user, connected to a further subnet in the same cluster, connecting to the web-server, the further subnet's geographical location can be inferred due to the fact that the two users share a common router.

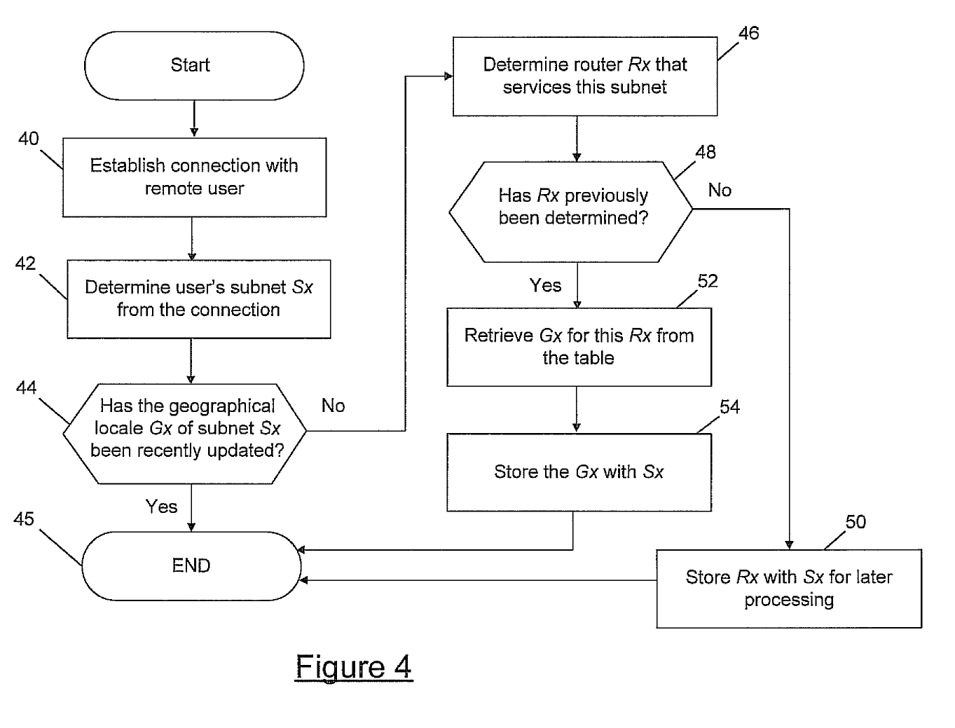

FIG. 4 is a flowchart of the method that is implemented by the software application 32 that controls web-server 30. At box 40 a connection is established between a remote user's machine and web-server 30. At box 42 the web-server determines the user's subnet Sx from the connection. At box 44 the web-server checks database table 35 to determine if the geographical location of subnet Sx has been recently updated. If the geographical location of Sx has not been recently updated, or has never been determined, then control diverts to box 46. In the alternative the processing ends at box 45. At box 46 the web-server determines the identity of the router Rx that services subnet Sx by using a method that will be described shortly. At box 48 the web-server checks to determine if there is an entry in database table 35 that relates router Rx to a geographical location Gx. That is, at this step a check is performed to determine whether or not a geographical service area for the router is already on record. Those skilled in the art will realise that, in a minority of cases, the router's physical geographical location may be different to that of the geographical location of its service area. However in practice this discrepancy has been found not to pose a problem as the router's geographical service area rather than its geographical location is recorded. If there is an entry for Rx then the web-server looks up its related geographical location Gx and stores Sx as being associated with Gx in its database at box 54. In the alternative, if there is no entry for router Rx in table 35 then at box 50 the web-server simply stores Sx as being associated with Rx so that in future when the geographical location Gx of router Rx is known then subnet Sx can be recorded as having geographical location Gx at that time.

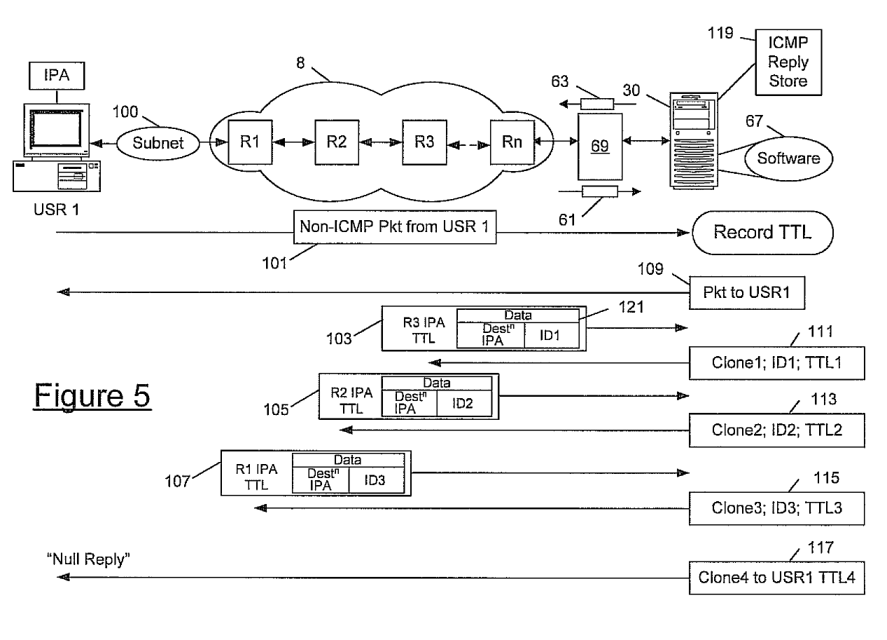

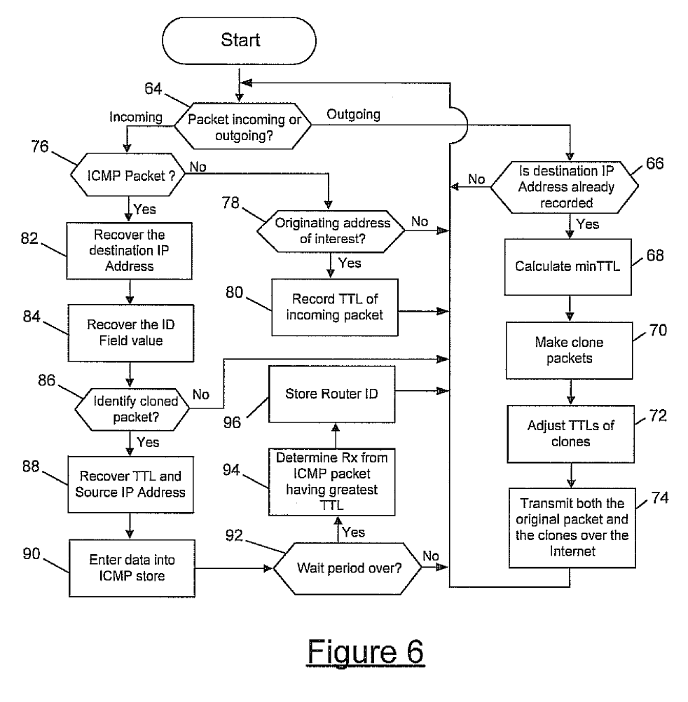

A method for obtaining the router associated with a subnet according to an embodiment of the present invention will now be explained with reference to FIG. 5 and the flowchart of FIG. 6. The method involves the use of a packet sniffer, depicted schematically as item 69 of FIG. 5. The packet sniffer is a virtual device created by packet sniffer software application 67 according to commonly known methods. Packet sniffer 69 checks and processes IP packets 61 entering the web-server and also IP packets 63 leaving the web-server. The packets entering the web-server may have originated from remote machine USR1 in response to that machine browsing to a web-page generated by webserver 30. Packet 101 is an example of such a packet. Alternatively, the packets entering the web-server may be internet control messaging protocol (ICMP) packets produced by routers R1, . . . , Rn in response to packets from webserver 30 having insufficient time-to-live (TTL) values to reach their destination. Examples of ICMP packets are shown as items 103, 105 and 107 in FIG. 5. Packet sniffer 69 stores certain information about ICMP packets in an ICMP Reply Store 119 which is simply a database table. On the basis of the information that is stored the packet sniffer is able to determine the identity of the router R1 closest to subnet 100. Packet sniffer application 67 is provided as a software product that bears instructions for one or more processors of web-server 30 to implement packet sniffer 69 and to cause it to execute a method, according to an embodiment of the present invention, that will now be described with reference to FIG. 6.

At box 64 the sniffer application determines if a packet is incoming or outgoing. If the packet is incoming and is not an Internet Control Message Protocol (ICMP) packet, for example packet 101 of FIG. 5, then at box 78 the sniffer application checks to determine whether or not the packets originating IP Address, e.g. IPA of FIG. 5, and hence its subnet, is of interest. For example, if the identity of the router servicing subnet 100 of FIG. 5 is unknown, then the originating IP Address will be deemed to be of interest and the method will then proceed to box 80. Alternatively, if the originating address is not of interest then the program loops back to box 64.

At box 80 the time-to-live (TTL) of packet 101 is recorded along with its originating IP Address, e.g. IPA, and a unique packet identifier. The process then loops back to box 64.

If at box 64 the packet being processed is an outgoing packet, e.g. packet 109 then the procedure progresses to box 66. Packet 109, in the present example, comprises a packet generated by web-server 30 in response to the initial packet 101 from the USR1 PC. Packet 109 has a destination address IPA and contains SPI data sufficient for it to be recognised by stateful routers, of routers R1, . . . , Rn, as a legitimate packet that has been solicited by USR1. Typically only the last few routers, e.g. router R1 will be stateful. Accordingly, the routers, including any stateful routers, will pass packet 109 to USR1.

As previously mentioned, in response to the increase in available processing power of modern CPUs and the demand for increased security, router manufactures have produced “stateful” routers being routers that keep track of the state of sessions at a higher level than has been the case in the past.

Server 30 is also programmed to assemble and transmit a number of probe packets 111-117 which are each based on solicited response packet 109. Each of the probe packets is substantially identical to packet 109 and so contains that packets SPI data, except for having a varied TTL value.

As will be seen, the probe packets are used to find the number of router hops to the router servicing subnet 100, i.e. router R1.

Referring again to FIG. 6, at box 66 a check is performed to determine if the packets 109 destination IP Address corresponds with an originating IP Address in the packet data database table. If it does match an IP Address in the packet data database table then at box 68 the minimum estimated TTL (minTTL) to reach the IP Address is calculated in a manner that will be explained shortly.

At box 70 probe packets 111-117 of IP packet 109 are assembled. Since the probe packets are copies of solicited reply packet 109, save for their adjusted TTL values, they contain sufficient SPI data to be passed by any stateful routers, e.g. R1, of the router chain R1, . . . , Rn.

At box 72 the UTL of the first probe packet 111 is set to an adjusted TTL of minTTL minus a shortfall. Currently the inventor uses a shortfall value of 5 hops. A method for determining the shortfall value will be described later.

The adjusted TTL is set to be incrementally greater for each of probe packets 113-117 so that at least one of the probe packets can be confidently expected to reach USR1 and at least one can be expected to fall short. At box 74 both the original unaltered IP packet and the probe packets are transmitted over the Internet. The process then loops back to box 64.

If, at box 64 an incoming packet, e.g. packet 103, is found to be an ICMP packet in response to one of the probe packets transmitted at box 74, then at box 82 the original destination IP Address is recovered from the IP header contained within the data section of the ICMP reply. At box 84 the original 16 bit Identification field of the IP header that is contained within the data section of the ICMP reply is recovered.

At box 86 the original IP Address and the ID field value are used to identify the probe packet which was transmitted at box 74, that the ICMP packet was generated in response to. If it is not possible to identify the probe packet then the procedure loops back to box 64. If it is possible to successfully identify the probe packet then at box 88 the TTL and source IP Address are recovered from the IP header of the ICMP response packet. It should be noted that they are not recovered from the IP header contained within the data section. The source IP Address will be the address of a router that replied to one of the cloned packets sent at box 74. For example, the source IP Address of Packet 105 is “R2 IPA”.

At box 90 the TTL and source IP Address of the ICMP response packet are stored for future reference.

At box 92 the sniffer application waits for a suitable time, say five seconds, for any further ICMP packet replies. In the present example the sniffer application receives ICMP packets 105 and 107.

At box 94 the recorded ICMP replies are examined to determine if there is sufficient data to identify the nearest router to the given subnet. The nearest router will be the router that has responded with the highest TTL before a nominal, say two,_number of NULL replies. In the present instance the nearest router to subnet 100 is R1. A NULL reply occurs when no ICMP reply is received in response to a sent probe packet as is the case with packet 117 of FIG. 5. A NULL reply indicates that the probe packet reached the destination IP Address. It will be realised that there are other conditions that may result in a NULL reply, for example packet loss, busy router, network anomaly etc. Consequently, as previously discussed, a sufficient number of probe packets are sent at box 74 with incremented TTLs to significantly increase the likelihood of identifying the correct router.

If the nearest router to the subnet in question, e.g. R1 in the example of FIG. 5, has been identified then at box 96 its particulars are recorded in a database table. The particulars in question include the destination subnet and/or IP Address of the cloned packet, the nearest router's IP Address, and the minimum TTL required to reach that router. Any subnets and the routers that service them that are incidentally discovered during the process are also recorded.

The method for calculating the minTTL that was mentioned previously in relation to box 68 will now be explained. Firstly, it is assumed that the vast majority of users will be using an operating system that initially sets the TTL to either 32, 64, 128 or 256 hops. As the TTL is stored within the IP Header as an 8-bit field it is not possible for this value to be larger than 255 and therefore no user can be more than 256 hops away.

If the TTL of the incoming packet is less than 32, 64, 128, 256 then the estimated minimum TTL required to reach the originating IP Address is 32, 64, 128, 256, less TTL of the incoming packets respectively. Examples of estimated minimum TTL values required to reach the originating IP Address are provided in Table 1. It will be noted that the sum of the entries in the first column and the third column equals the entry in the second column.

TABLE 1

| | Assumed initial TTL, | Estimated Minimum TTL |
|---|---|---|
| TTL of Incoming | either | required to reach the |
| Packet | 32, 64, 128, 256 | originating IP Address |
| 14 | 32 | 18 |
| 41 | 64 | 23 |
| 110 | 128 | 18 |
| 230 | 256 | 26 |

The determination of the TTL offset value that was previously mentioned in relation to box 72 of FIG. 6 will now be discussed. The inventor has found that the number of hops required to reach a destination address is often not the same as the number of return hops incurred by a packet traversing the network in the opposite direction. This is primarily because packets may travel a different path in each direction traversing both different routers and a different number of routers on each path. This is why the “Estimated minimum TTL is only an estimate and why a TTL offset is required. The TTL offset is used to back up and start mapping at a point which is likely to be equal or less than the minimum TTL required to reach the nearest router. This in turn allows efficient mapping, with a minimal number of packets being sent. However, in a small number of cases the estimated TTL less the offset will still be too high so that no ICMP replies are elicited. In that case the probe packets' TTLs are further reduced until such time that an ICMP reply is received.

It will be realised that a further advantage of a method according to an embodiment of the present invention is that it is very discreet insofar as it does not cause ISPs to mistakenly interpret the probe packets as an ICMP attack because they are each based upon a solicited response packet.

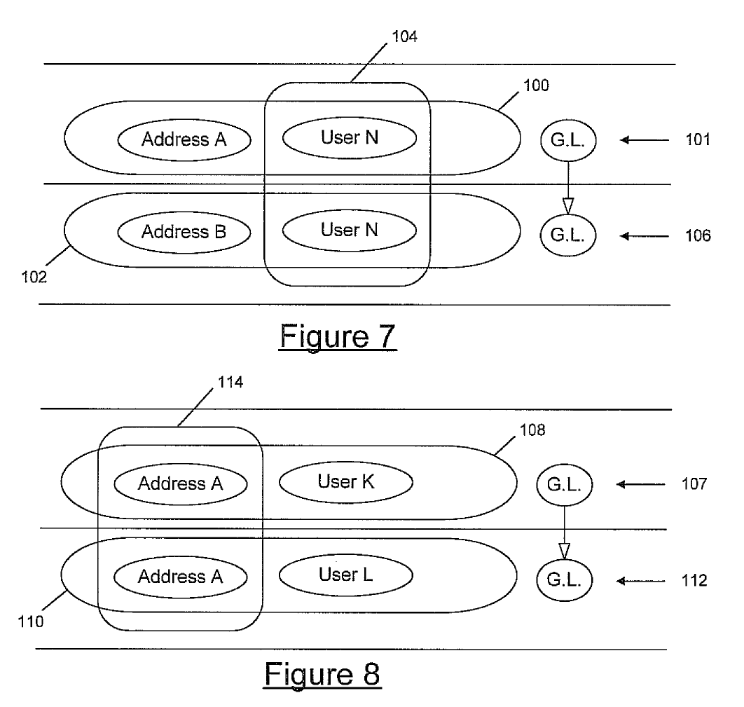

FIGS. 7 to 9 schematically illustrate three broad approaches to associating a geographical location with network data including a network edge (e.g. “subnet”) address according to previously described preferred embodiments of the present invention. These diagrams may be taken to represent examples of the kind of data that might be stored in table 12 of FIG. 1.

In FIG. 7 seed data is stored in row 101 comprising the association of network data 100, including network edge Address A and User N with geographical location G.L. Upon ascertaining new network data 102 comprising network edge Address B and associated User N then User N, being common to both rows is taken to comprise pivot data 104 and geographical location G.L. is then copied to the lower row 106 so that it is associated with network address B.

In FIG. 8 seed data is stored in row 107 comprising the association of network data 108, including Network Edge Address A and User K, to geographical location G.L. Subsequently new network data 110, indicating that Network Address A is associated with User L, is ascertained and stored in row 112. Since Network Address A is common to both rows it comprises pivot data 114 and accordingly the geographical location G.L. is then copied to row 112 so that User L is also associated with geographical location G.L.

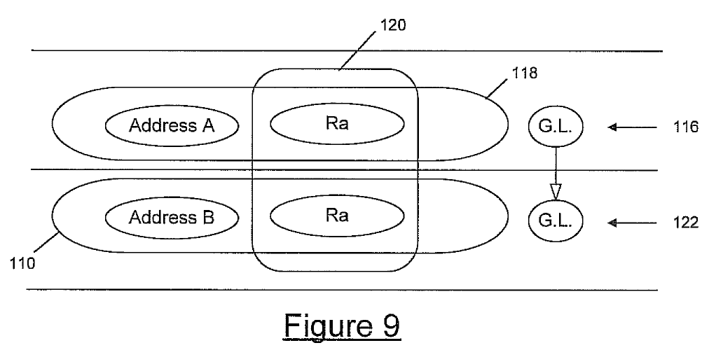

In FIG. 9 seed data is stored in row 116 associating Network Edge Address A to a network support device Ra, e.g. a router having address Ra and to a geographical location G.L. Subsequently, new network data 110 is ascertained indicating that Network Edge Address B is also associated with network support device Ra. Since Ra in the second row matches Ra in the first row, the router address can be used as pivot data 120. Consequently Address B is then associated with geographical address G.L. by copying G.L. to row 122 as indicated.

The embodiments of the invention described herein are provided for purposes of explaining the principles thereof, and are not to be considered as limiting or restricting the invention since many modifications may be made by the exercise of skill in the art without departing from the scope of the appended claims

What is claimed is:

1. A method to associate a geographical location with network data including network edge address data and corresponding pivot data, the method including the steps of:
storing network data with corresponding known geographical locations;
subsequent to ascertaining new network data checking if pivot data contained therein matches pivot data of said stored network data; and if so
associating the new network data with a geographical location previously associated with said matched pivot data.

2. A method according to claim 1, wherein the network data comprises any one of the following:
network edge address data associated with a remote user identifier; or
network edge address data associated with a network support device address.

3. A method according to claim 2, wherein the network data comprises network edge address data associated with a remote user identifier and wherein the network edge address data comprises the pivot data.

4. A method according to claim 2, wherein the network data comprises network edge address data associated with a remote user identifier and wherein the remote user identifier comprises the pivot data.

5. A method according to claim 2, wherein the network data comprises network edge address data associated with a network support device address and wherein the network support device address data comprises the pivot data.

6. A method according to claim 5, further including ascertaining the network support device address across a computer network by:
obtaining stateful packet inspection (SPI) data from a reply packet from a remote computer connected to the network support device;
transmitting a number of probe packets addressed to the remote computer, said packets incorporating sufficient of said SPI data for the probe packets to be passed by SPI security devices of the computer network; and
deriving the network support device address on the basis of reply packets generated in response to at least some of the number of probe packets.

7. A method according to claim 6, including adjusting time-to-live (TTL) values of the probe packets so that they take a range of TTL values wherein the TTL to the remote computer falls within said range whereby at least some of the probe packets fall short of the remote computer thereby eliciting said reply packets.

8. A method according to claim 7, including:
determining probe packets having the greatest TTL of said range to elicit a reply packet;
obtaining the IP Address of a device of origin of the reply packet; and
deducing the network support device address on the basis of said IP Address.

9. A method according to claim 7, including:
sending the probe packets with consecutively increasing TTL values until an ICMP reply packet is not received, whereby the last received reply packet is sent from the network support device.

10. A method according to claim 7, including:
sending the probe packets with consecutively decreasing TTL values until an ICMP reply packet is received, whereby the received reply packet is sent from the network support device.

11. A method for deriving information about a remote network connection across a computer network, the method including the steps of:
obtaining stateful packet inspection (SPI) data from a reply packet solicited from a remote computer party to the remote network connection;
transmitting a number of probe packets addressed to the remote computer, said packets incorporating sufficient SPI data for the probe packets to be passed by SPI security devices of the computer network; and
deriving the information on the basis of reply packets generated in response to at least some of the number of probe packets.

12. A method according to claim 11, including adjusting the time-to-live (TTL) values of the probe packets so that they take a range of TTL values wherein the TTL to the remote computer falls within said range whereby at least some of the probe packets fall short of the remote computer thereby eliciting said reply packets.

13. A method according to claim 11, wherein the information about the remote network connection comprises the address of the router to which the remote computer is attached.

14. A method according to claim 13, including:
determining probe packets having the greatest TTL of said range to elicit a reply packet;
obtaining the IP Address of a device of origin of the reply packet; and
deducing the address of the router to which the remote computer is attached on the basis of said IP Address.

15. A method according to claim 14, including:
sending the probe packets with consecutively increasing TTL values until a reply packet is not received from a router, whereby the last received reply packet is sent from the closest router to the remote computer.

16. A method according to claim 14, including:
sending the probe packets with consecutively decreasing TTL values until a reply packet is received from a router, whereby the received reply packet is sent from the closest router to the remote computer.

17. A method according to claim 14, including:
maintaining a record of subnet addresses; and
determining whether or not the reply packet has been solicited from a remote computer whose subnet address is already recorded in said record.

18. A method according to claim 17, including adding the subnet address to said record if the subnet address is not already recorded in said record.

19. A method according to claim 18, wherein each address indicator in said record has an associated username.

20. A method according to claim 19, wherein each address indicator in said record will have an associated geographical location.

21. A method according to claim 10, including:
establishing a connection with a remote computer;
obtaining a user identifier provided by an operator of the remote computer;
determining a geographical location corresponding to the username from the record; and
associating the geographical location with a subnet address derived from the connection.

22. A method according to claim 11 including:
corresponding the determined geographic location with one of a plurality of stored advertisements each having an associated geographic location; and
displaying the corresponding advertisement on a website to which the remote computer is connected.

23. A method according to claim 14, including:
establishing a connection with a remote computer;
determining a subnet address for the remote computer;
determine the identity of a router that services the subnet address;
retrieving a geographical location corresponding to the router identity; and
associating the geographical location with the subnet address.

24. A computer software product containing instructions for execution by one or more processors in order to implement a method according to claim 1.

25. A computer software product containing instructions for execution by one or more processors to implement a method according to claim 11.
